(19) United States
(12) Patent Application Publication
(10) Pub. No.: US 2013/0271853 A1
(43) Pub. Date: Oct. 17, 2013

(54) OPTICAL LENS ASSEMBLY

(71) Applicants: Ching-Shan Yang, Tainan (TW); Wu-Li Wang, Tainan (TW)

(72) Inventors: Ching-Shan Yang, Tainan (TW); Wu-Li Wang, Tainan (TW)

(73) Assignee: GLOBAL MICROPTICS COMPANY, Tainan (TW)

(21) Appl. No.: 13/446,187

(22) Filed: Apr. 13, 2012

(51) Int. Cl. G02B 9/04

(52) U.S. Cl. 359/793

(57) ABSTRACT

An optical lens assembly includes a first lens, an adhesive layer, and a second lens in sequence. The adhesive layer is made of adhesive macromolecular compounds to adhere both sides thereof to interior sides of the first lens and the second lens, and the adhesive layer has following conditions: a transmittance greater than 70%; |n3−n1|<0.5; and |n3−n2|<0.5; where n1 is a refractive index of the first lens; n2 is a refractive index of the second lens; and n3 is a refractive index of the adhesive layer.

### BACKGROUND OF THE INVENTION

1. Field of the Invention

The present invention relates generally to an optical device, and more particularly to an optical lens assembly.

2. Description of the Related Art

In recent days, more and more image pick-up apparatus, such as digital camera and cell phone, are equipped with an image capture device, such as charge coupled device (CCD) or complementary metal oxide semiconductor (CMOS), and theses image pick-up apparatus are made as smaller as possible so that the image capture devices are asked as smaller as possible as well.

FIG. 1 shows a conventional miniature lens assembly, including a first lens 40 and a second lens 50 attached to the first lens 40. The second lens 50 is stacked on the first lens 40 and attached thereto through their boundaries 41 and 51 so that interior sides 42, 52 thereof are separated with air therebetween.

When light L2 emits through the first and the second lenses 40, 50 other than in the normal direction, as shown in FIG. 2, there will be a light shift because of passing through the second lens 50, air, and the first lens 40 in sequence, and therefore a transmittance of the light L2 is poor. In order to compensate the light shift, it may have to increase the distance between the interior sides 42, 52 of the first and the second lenses 40, 50. However, it will enlarge the size of the lens assembly 2.

### SUMMARY OF THE INVENTION

The primary objective of the present invention is to provide an optical lens assembly, which has a low light shift, high transmittance, and small size.

According to the objective of the present invention, an optical lens assembly includes a first lens, an adhesive layer, and a second lens in sequence. The adhesive layer is made of adhesive macromolecular compounds to adhere both sides thereof to interior sides of the first lens and the second lens, and the adhesive layer has following characters:
a transmittance greater than 70%;
   |n3−n1|<0.5; and
   |n3−n2|<0.5;

where n1 is a refractive index of the first lens; n2 is a refractive index of the second lens; and n3 is a refractive index of the adhesive layer.

In an embodiment, a space is formed between the first lens and the second lens, and the adhesive layer is put in the space.

In an embodiment, a sum of radiuses of curvature of the interior sides of the first lens and the second lens is not equal to zero.

In an embodiment, a thickness of the adhesive layer is greater than 1 micrometer.

In an embodiment, a refractive index of the adhesive layer is greater than 1.

In an embodiment, a refractive index of the adhesive layer is in a range between 1.2 and 1.8.

In an embodiment, the adhesive layer has a strength of adhesion greater than 1 kgf/m².

In an embodiment, the adhesive layer has a strength of adhesion greater than 500 kgf/m².

Therefore, the optical lens assembly of the present invention has a low light shift, high transmittance, and small size to be fitted into a small image pick-up apparatus.

### BRIEF DESCRIPTION OF THE DRAWINGS

FIG. 1 is a sketch diagram of the conventional lens assembly;

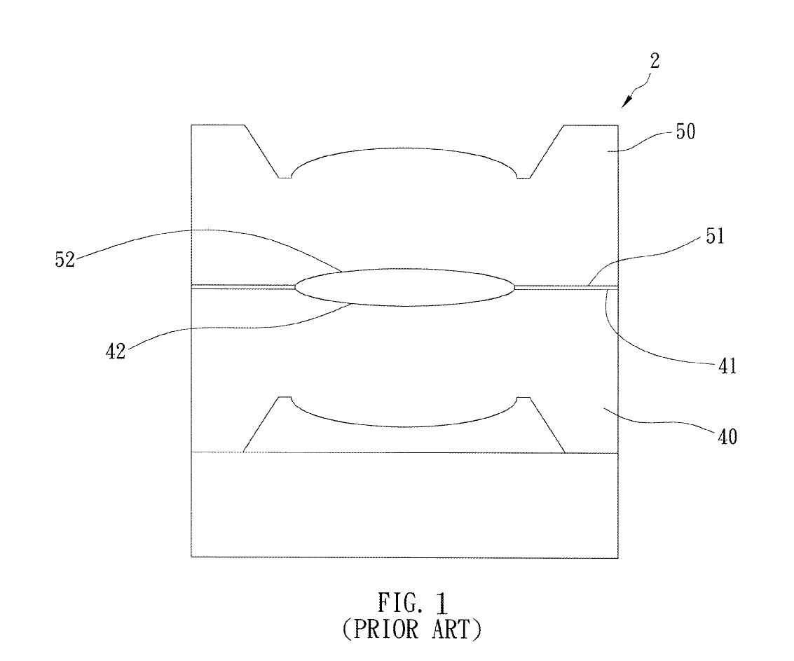

FIG. 2 is a sketch diagram of the conventional lens assembly, showing the light path;

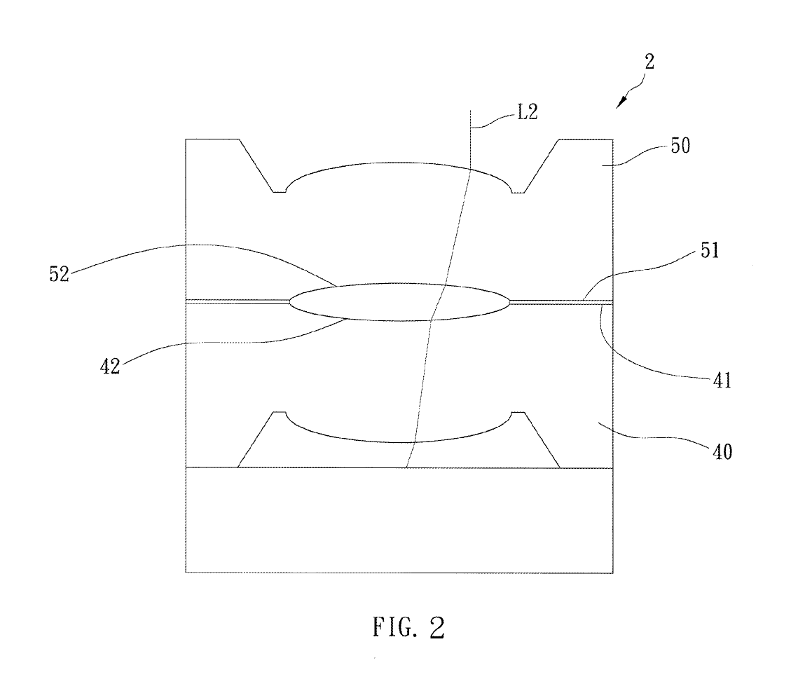

FIG. 3 is a sketch diagram of a preferred embodiment of the present invention; and

FIG. 4 is a sketch diagram of the first preferred embodiment of the present invention showing the light path.

### DETAILED DESCRIPTION OF THE INVENTION

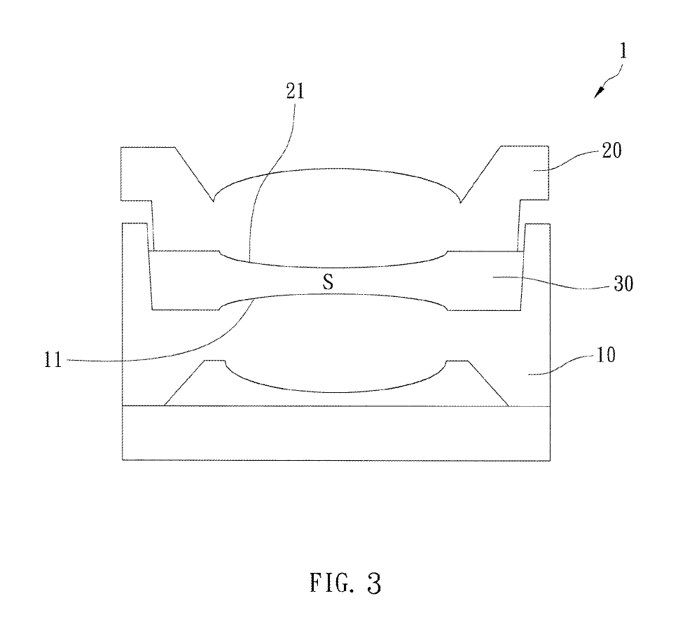

As shown in FIG. 3, an optical lens assembly of the preferred embodiment of the present invention includes a first lens 10, an adhesive layer 30, and a second lens 20 in sequence.

The first and the second lenses 10, 20 respectively have an interior side 11, 21, and a space S is formed therebetween. The interior sides 11, 21 respectively have a radius of curvature, and the radius of curvature of the interior side 11 plus the radius of curvature of the interior side 12 does not equal zero (0). In the present embodiment, refractive indexes of the first and the second lenses 10, 20 are 1.5, and they may have any refractive index accordingly.

The adhesive layer 30 is made of adhesive macromolecular compounds to be put in the space S and adhere its opposite sides to the interior side 11, 21 of the first and the second lenses 10, 20. A strength of adhesion of the adhesive layer 30 is preferred greater than 1 kgf/m², and it is greater than 500 kgf/m² in the present embodiment to provide a better adhesion.

Except for the strength of adhesion the adhesive layer 30 further has to meet the following characters:
1) Light transmittance greater than 70%;
2) |n3−n1|<0.5; and
   |n3−n2|<0.5;
where
n1 is a refractive index of the first lens 10;
n2 is a refractive index of the second lens 20; and
n3 is a refractive index of the adhesive layer 30.

In the present embodiment, the light transmittance of the adhesive layer 30 is greater than 95%, and its refractive index is in a range between 1 and 2, and more preferable range is between 1.2 and 1.8. In practice, the refractive index n3 of the adhesive layer 30 changes based on the refractive indexes n1, n2 of the first and the second lenses 10, 20.

Because of the wavelength of light, a thickness of the adhesive layer 30 is greater than 1 micrometer (μm) to change the optical characters when light emits through the adhesive layer 30.

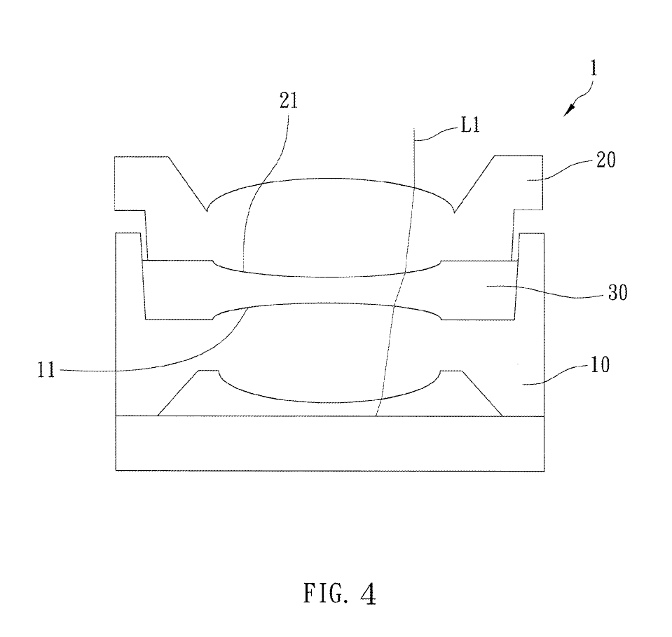

As shown in FIG. 4, the optical lens assembly of the present invention will have a small light shift and high transmittance when light L1 emits therethrough. Besides, the optical character of the optical lens assembly of the present invention will change because of the adhesive layer 30 which means it may reduce the amount of lenses by using the particular adhesive layer 30. As a result, the optical lens assembly of the present invention may have a small size to be squeezed into the image pick-up apparatus of the present days.

The description above is a few preferred embodiments of the present invention and the equivalence of the present invention is still in the scope of claim construction of the present invention.

What is claimed is:

1. An optical lens assembly, comprising a first lens, an adhesive layer, and a second lens in sequence, wherein the adhesive layer is made of adhesive macromolecular compounds to adhere both sides thereof to interior sides of the first lens and the second lens, and the adhesive layer has following characters: a transmittance greater than 70%; |n3−n1|<0.5; and |n3−n2|<0.5; where n1 is a refractive index of the first lens; n2 is a refractive index of the second lens; and n3 is a refractive index of the adhesive layer.

2. The optical lens assembly as defined in claim 1, wherein a space is formed between the first lens and the second lens, and the adhesive layer is received in the space.

3. The optical lens assembly as defined in claim 1, wherein a thickness of the adhesive layer is greater than 1 micrometer.

4. The optical lens assembly as defined in claim 1, wherein the refractive index of the adhesive layer is in a range between 1 and 2.

5. The optical lens assembly as defined in claim 1, wherein the refractive index of the adhesive layer is in a range between 1.2 and 1.8.

6. The optical lens assembly as defined in claim 1, wherein the adhesive layer has a strength of adhesion greater than 1 kgf/m².

7. The optical lens assembly as defined in claim 1, wherein the adhesive layer has a strength of adhesion greater than 500 kgf/m².

8. The optical lens assembly as defined in claim 1, wherein a sum of radiuses of curvature of the interior sides of the first lens and the second lens is not equal to zero.

9. The optical lens assembly as defined in claim 1, wherein the transmittance of the adhesive layer is greater than 95%.
